(19) United States
(12) Patent Application Publication
(10) Pub. No.: US 2022/0382763 A1
(43) Pub. Date: Dec. 1, 2022

(54) POPULATING SEARCH RESULTS WITH INTENT AND CONTEXT-BASED IMAGES

(71) Applicant: DELL PRODUCTS, LP, Round Rock, TX (US)

(72) Inventors: Parminder Singh Sethi, Punjab (IN); Shibi Panikkar, Bangalore (IN); Annanya Chowdhury, Jamshedpur (IN)

(21) Appl. No.: 17/329,421

(22) Filed: May 25, 2021

(51) Int. Cl. G06F 16/2457; G06F 16/242; G06F 16/951; G06F 40/40

(52) U.S. Cl. CPC G06F 16/24575; G06F 16/242; G06F 16/951; G06F 40/40

(57) ABSTRACT

An information handling system receives a search query determines a first key attribute associated with a first search term and a second key attribute associated with a second search term, determines an intent of a user and context of the search query based on the first key attribute, and determines whether the search result corresponding to the search query includes an image with a first feature corresponding to the first key attribute and a second feature corresponding to the second key attribute. Responsive to a determination that the search result does not include the image with the first feature and the second feature, the system may generate a clubbed image that includes a first image and a second image, wherein the first image includes the first feature and the second image includes the second feature.

### FIELD OF THE DISCLOSURE

The present disclosure generally relates to information handling systems, and more particularly relates to populating search results with intent and context-based images.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system receives a search query determines a first key attribute associated with a first search term and a second key attribute associated with a second search term, determines an intent of a user and context of the search query based on the first key attribute, and determines whether the search result corresponding to the search query includes an image with a first feature corresponding to the first key attribute and a second feature corresponding to the second key attribute. Responsive to a determination that the search result does not include the image with the first feature and the second feature, the system may generate a clubbed image that includes a first image and a second image, wherein the first image includes the first feature and the second image includes the second feature.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating a system for populating search results with intent and context-based images, according to an embodiment of the present disclosure;

FIG. 3 is a block diagram illustrating a system for populating search results with intent and context-based images, according to an embodiment of the present disclosure;

FIG. 4 is a block diagram illustrating a system for populating search results with intent and context-based images, according to an embodiment of the present disclosure;

FIG. 5 is a diagram illustrating a page with a search query and search results, according to an embodiment of the present disclosure;

FIG. 6 is a flowchart illustrating a method for populating search results with intent and context-based images, according to an embodiment of the present disclosure; and

FIG. 7 is a flowchart illustrating a method for populating search results with intent and context-based images, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

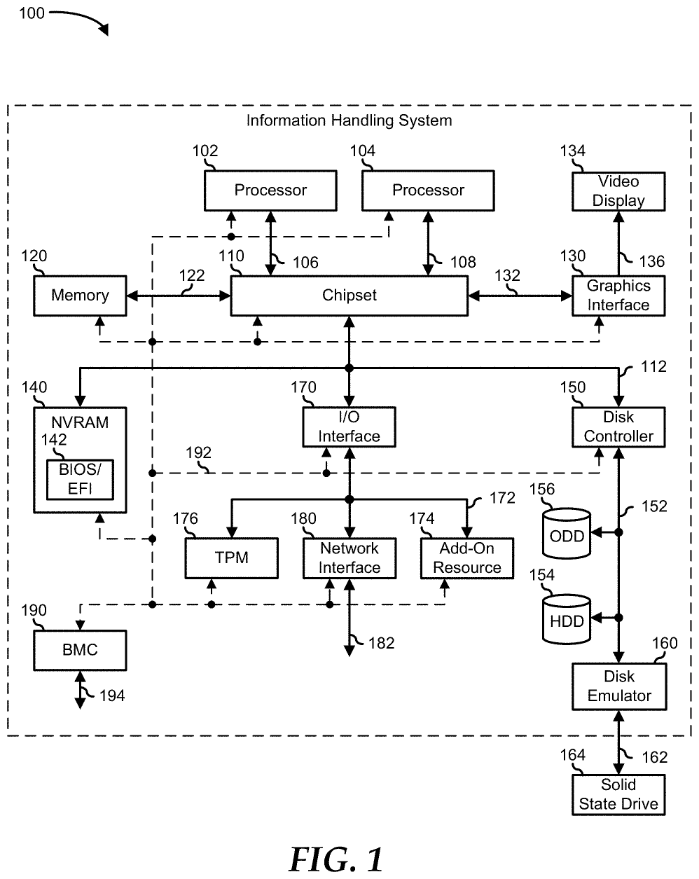

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random-Access Memory (DRAM) DIMMs, Static Random-Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on a separate circuit board or add-in card disposed within information handling system 100, a device that is external to the information handling system, or a combination thereof

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof

BMC 190 is connected to multiple elements of information handling system 100 via one or more management interface 192 to provide out-of-band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor-defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

When a user conducts a search query, such as for a particular product or item, a search result may return the wrong image and/or unwanted information. The returned image and information may not include relevant information based on the search query. The image may be misleading, be too generic, associated with misleading information or include no information. For example, if a user performs a search query for a particular portable computer, the search results may include generic images and irrelevant information.

Currently, various systems allow a customer or user to search for a product. However, search results typically do not address a customer's specific intent. Generic images are generally provided to the user and the user has to navigate through a myriad of search results to find one that satisfies their need or desired result. A search query by the user may contain some specific requirements and/or features. However, often the results provided by various search engines do not include the images related to the specific requirements and/or features. Typically, the search results include text and/or links with no image. The search results may also include a standard fixed image shown with some text or no text at all.

For example, a user may search for a laptop computer with three USB ports, an HDMI port, and a video graphics array (VGA) slot. Typically, the images shown with the search result are static and generic. A search result that specifically shows images of a laptop with three USB ports, an HDMI, and a VGA slot is not typically shown. A user would typically have to click each laptop image and view whether that laptop has the desired three USB ports with HDMI and a VGA slot. This is inefficient and time-consuming. Thus, there is a need to provide search results with images that are relevant to the user's query. As such in the example above, it would be desirable to have images that visibly show laptops with three USB ports, HDMI and a VGA slot in the search results. To address the above and other concerns, a system and method are disclosed herein that automatically populate the search result with product images based on the user's intent and context of the search.

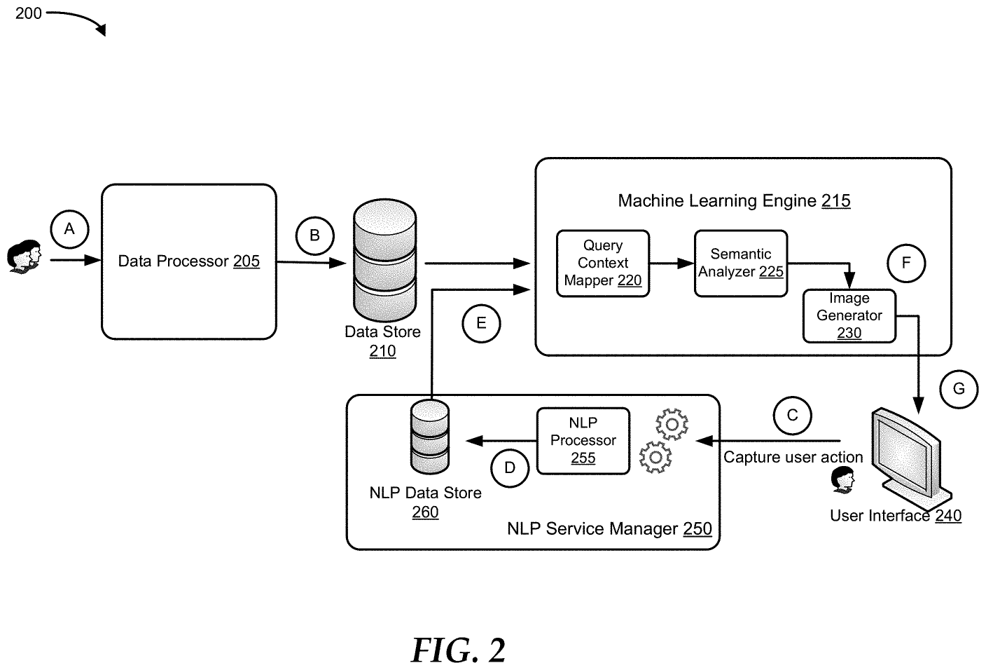

FIG. 2 illustrates a system 200 for automatically populate a search result with query-based images based on the user's intent and search context. System 200 may be configured to determine a user's intent as to the search query and provide the search result based on the user's intent and contextual information. System 200 also incorporates historical data or telemetry and the user's search interactions in the analysis. System 200 includes a data processor 205, a data store 210, a machine learning engine 215, a user interface 240, and neuro-linguistic programming (NLP) service manager 250. The components of system 200 may be implemented in hardware, software, firmware, or any combination thereof. The components shown are not drawn to scale and system 200 may include additional or fewer components. In addition, connections between components may be omitted for descriptive clarity.

Data processor 205 may be configured to retrieve information and/or images from various sites, environments, or platforms such as vendor support sites, social networking sites, electronic commerce sites, online shopping sites, product websites, and data repositories. In one embodiment, data processor 205 may include a web crawler/agent to interact with the aforementioned sites, environments, or platforms to crawl for images or information such as product or item data. In certain embodiments, data processor 205 includes one or more search engines in performing its search for information and/or images. The retrieved information and/or images may be stored at data store 210.

NLP service manager 250 may be configured to analyze the search query to determine the intent of the user and the context data associated with the search query. Analysis of the search query may include tokenization, sentence segmentation, part of speech tagging, lemmatization, etc. NLP service manager 325 may include at least one component to perform one or more of the above functions. For example, NLP service manager 325 may include a tokenizer, a part-of-speech tagger, a lemmatization engine, etc. NLP service manager 325 may include OpenNLP™, natural language toolkit, Stanford CoreNLP™, etc. The above components may be included as part of an NLP processor 255.

NLP processor 255 may be configured to predict the user's intent and subsequent actions according to one or more search terms in the search query. The search terms may be used to determine the key attributes to be used in predicting the user's intent and the context of the search query. The user's intent and actions may be converted into one or more keywords to be used in predicting trends. An NLP model may be used to determine user statistics, product and/or item descriptions, user search queries, and trends. NLP data store 260 may be used to store the keywords, user statistics, product and/or item descriptions, user search queries, trends, and other information to be used in the analysis.

Machine learning engine 215 includes a query context mapper 220, a semantic analyzer 225, and an image generator 230. Query context mapper 220 may be configured to perform the text to context mapping, wherein the text refers to the search terms in the search query. The text of the search query may include one or more search terms. Semantic analyzer 225 may be configured to perform semantic keyword filtering based on the context mapping. Image generator 230 may be configured to generate an image by combining one or more images based on one or more keys also referred to as key attributes associated with the search query.

Machine learning engine 215 and NLP service manager 250 may be used to understand the user's intent and the context of the search query and populate the search result with information and/or images accordingly. Machine learning engine 215 and NLP service manager 250 may be used to analyze historical information associated with user statistics, user's query, and trends based on the user's behavior which may be used to infer the user's intent based on contextual information associated with the search query. Machine learning engine 215 may use various machine learning techniques such as convolutional neural networks, graph neural networks, graph convolutional networks, recurrent neural networks, etc. A machine learning model may take as input content and filter keys associated with product or item information such as its features and/or attributes and outputs a set of images for the search result. The information, product, item, etc. being searched can have more than one image that is customized for different users using machine learning and NLP techniques for populating search results with customized images that may be generated using text context mapping, filtering, and image analysis.

In one embodiment, machine learning engine 215 may use a convolutional neural network to predict a set of images with features that match one or more key attributes of the search query from images stored in data store 210. The search results may be ranked based at least on the number of matches with the image with the maximum number of features that match key attributes of the search query. Another image with the next maximum number of features that match key attributes of the search query may be combined with a different image with features that match the remaining key attributes of the search query. For example, given a search query for a laptop with three USB ports with an HDMI and a VGA slot, a top-ranked image of a laptop may have all the key attributes: three USB ports, an HDMI slot, and a VGA slot. A second-ranked image of a laptop may have two of the three key attributes, such as an image of a laptop with three USB ports and an HDMI slot. The second-ranked image may be combined with another image of the laptop with a VGA slot. One or more limitations may be enforced such as the two combined images be of the same domain that is both are laptops. In addition, the laptop images are of the same model number.

Machine learning engine 215 and NLP service manager 250 may be configured to automatically populate the search results with one or more images associated with the domain or object of the search query. NLP service manager 250 and machine learning engine 215 are based on a network of NLP embedded with a machine learning model and a convoluted neural network. This network may be configured to generate one or more images, referred to herein as a “clubbed image” which includes features that highlight the requirements and/or features associated with the search query as depicted above. These images are shown to the user as part of the search query results. Combining at least two images may be performed if the search query cannot be satisfied by a single image or in addition to the single image.

User interface 240 may be configured to receive user input and display search results. For example, user interface 240 may be configured to accept a search query from the user and display at least a portion of search results. User interface 240 may be of different types of devices, such as a mobile device, a personal computer, or any other suitable device that may vary in size, shape, performance, or functionality. For example, the device may be a smartphone, tablet, desktop, laptop, notepad, notebook, etc. User interface 240 may permit the user to input the search query via a keypad, a keyboard, touch screen, microphone, camera, and/or other data input device. User interface 240 may also permit the information handling system to communicate the search results to the user via a display device, speaker, and/or other data output device. User interface 240 may include one or more of a display, microphone, camera, and speaker. The term “user” in this context should be understood to encompass, by way of example and without limitation, a user device, a person utilizing or otherwise associated with the device, or a combination of both. An operation described herein as being performed by a user may therefore be performed by a user device, or by a combination of both the person and the device.

FIG. 2 is annotated with a series of letters A-G. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A, data processor 205 may be configured to gather information and/or images from various sources. For example, data processor 205 may gather product information of various products and/or objects. The product information may include a set of attributes and/or properties in addition to the images gathered as part of the product information. The production information may be gathered from various sources such as vendors. In an embodiment, gathering the product information can be performed at regular intervals, such as hourly, daily, weekly, monthly, or the like.

The information is then stored in data store 210 at stage B. The information may be classified according to a domain before storage. Each organization typically has different domains. For example, for an organization that sells computers and related devices, the organization may include the following as domains: laptop, server, storage server, desktop, etc. Under each domain, an “image-key” may be defined which is associated with one or more attributes and/or features for the object that is being classified. The information may be classified into various domains attributes, and/or inter-relationships. The attributes may be associated with keywords or search terms that users are expected to use during a search. The classification may use a tree format which allows a search query to be more efficient. Following is an exemplary illustration of a domain classification:

Classification—Laptop
Images
   Laptop_with_VGA.jpg
      Key—VGA
   Laptop_with_port.jpg
      Key—USB
      Key—Port
      Key—HDMI
      Key—Slot
      Key—HDMI Slot

At stage C, system 200 receives a search query from the user via user interface 240. In addition, system 200 may capture user actions and interactions associated with the search query. The user actions and interactions may include past interactions such as items viewed, items purchased, or the like. The interactions may also include items or results that the user clicks or selects from a list of search results. In addition, the interactions may include purchases, search queries that were abandoned, ratings and reviews provided by the user, etc. Finally, the interactions may include purchase history, past queries by the user, past sessions, or the like.

At stage D, NLP service manager 250 may predict the user's intent and subsequent action. The prediction may be converted into keywords or key attributes and passed as input to machine learning engine 215 at stage E. At stage F, machine learning engine 215 may perform a search term to context mapping, filtering of semantic keywords, and generating a set of images for the search results. At stage G, the set of images may be ranked and displayed at the user interface for the user.

Those of ordinary skill in the art will appreciate that the configuration, hardware, and/or software components of system 200 depicted in FIG. 2 may vary. For example, the illustrative components within system 200 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

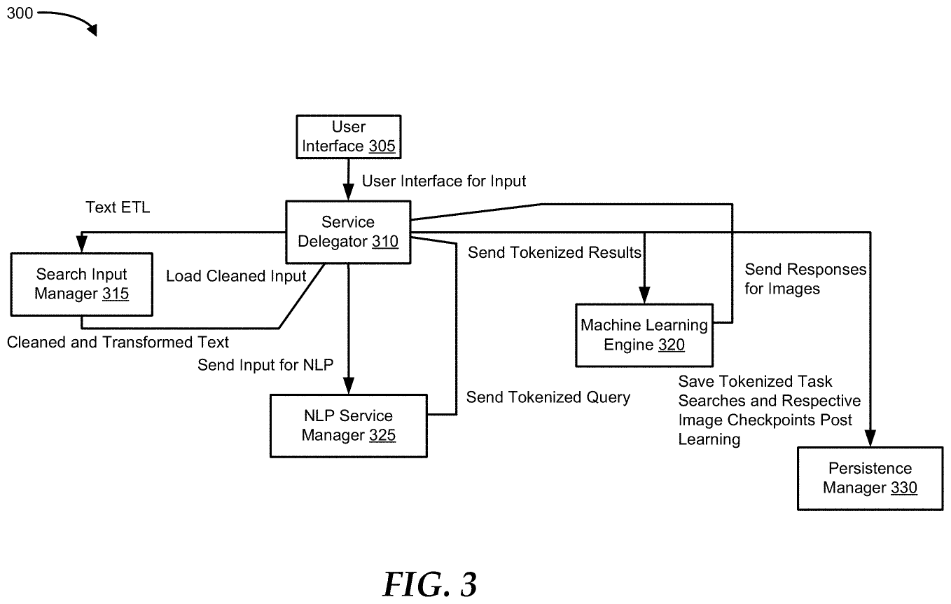

FIG. 3 illustrates a system 300 for automatically populating a search result with query-based images based on the user's intent and search context. System 300, similar to system 200 may be configured to determine a user's intent as to the search query and provide a search result based on the user's intent and contextual information. System 300 highlights in detail at least a portion of system 200. System 300 includes a user interface 305, a service delegator 310, a search input manager 315, a machine learning engine 320, an NLP service manager 325, and a persistence manager 330. The components of system 300 may be implemented in hardware, software, firmware, or any combination thereof. The components shown are not drawn to scale and system 300 may include additional or fewer components. In addition, connections between components may be omitted for descriptive clarity.

Service delegator 310 may be configured to manage and/or coordinate functions of various components of system 300. In addition to component management, service delegator 310 may be configured to control data flow between the components. Search input manager 315 may be configured to perform extract, transform, load (ETL) operations on a search query and load the transformed and/or cleaned data to service delegator 310. After receiving the transformed and/or cleaned data, service delegator 310 then may call for NLP service manager 325 to perform sentence decomposition also referred to as tokenization, removal of stop words, stemming if desired, lemmatization, and key extraction/feature extraction. Also, NLP service manager 325 may derive the intent and image-key attributes for the context-based search. In addition, NLP service manager 325 may generate a template as an output. The template may include image keys and/or features based on the search query and send the template to service delegator 310.

Service delegator 310 may be configured to parse the template and determine the image-key(s) in the template and send those to machine learning engine 320. Machine learning engine 320 takes the image-key(s) as input. Based on the input, machine learning engine 320 determines whether there is a classified and/or generated image for a similar search query. If there is no classified and/or generated image, then machine learning engine 320 may perform a search for an image based on the image-key(s). Machine learning engine 320 may also combine one or more images to generate a clubbed image. The image and/or clubbed image may be sent to service delegator 310 to automatically populate the search result. Service delegator 310 may be configured to save learned checkpoints into a data store which is managed by persistence manager 330.

The machine learning engine 320 may recognize an image associated with the search query by matching context data associated with the search query to one or more tags associated with the image. If machine learning engine 320 can find an image that matches all the features of the context data to all of the tags of the image, then that image is selected and outputted for the user, such as if a single image has all the tags present in its feature tag list. Otherwise, machine learning engine 320 searches for an image whose tags have the most number of matches. If machine learning engine 320 can find an image with the most or maximum number of matches between the context data and the tags associated with the image, then machine learning engine 320 may determine that context data that did not match the tags of the image. Machine learning engine 320 may search for an image with tags that matches the remaining features in the context data. Machine learning engine 215 may combine these images into one clubbed image which is then outputted for the user.

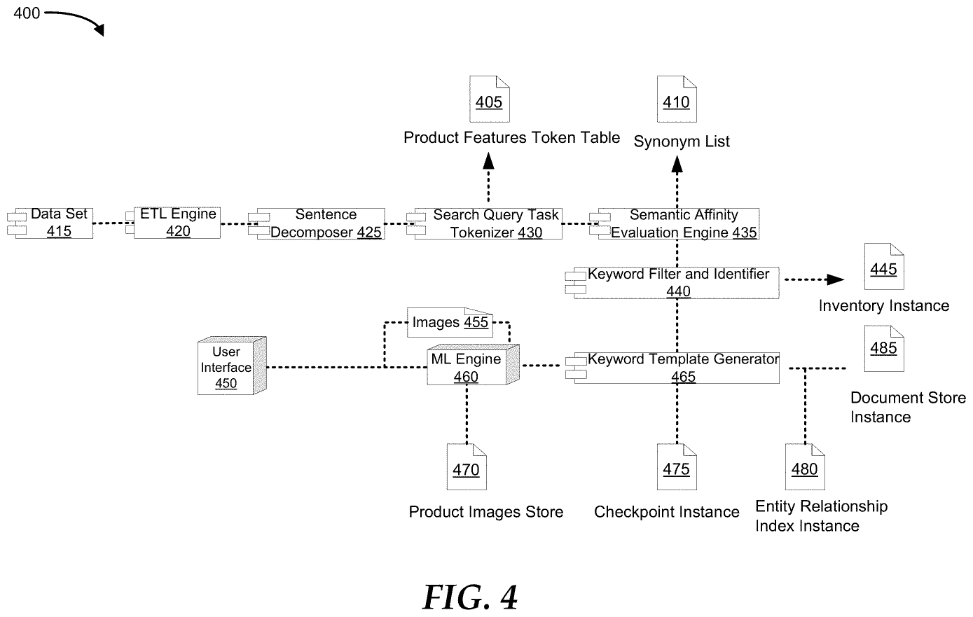

FIG. 4 shows a system 400 for automatically populating a search result with query-based images. System 400, which is similar to system 300 may be configured to determine a user's intent as to the search query and provide a search result based on the user's intent and contextual information. System 300 includes data set 415, an ETL engine 420, a sentence decomposer 425, a search query task tokenizer 430, a semantic affinity evaluation engine 435, a keyword filter and identifier 440, a machine learning engine 460, and a keyword template generator 465. The components of system 300 may be implemented in hardware, software, firmware, or any combination thereof. The components shown are not drawn to scale and system 300 may include additional or fewer components. In addition, connections between components may be omitted for descriptive clarity.

Data set 415 may include information, images, files, records, etc. that were extracted and/or crawled from one or more sites, platforms, and/or environment. ETL engine 420 may be configured to execute one or more ETL jobs to transform data set 415 and load the transformed data set to a data store and/or sentence decomposer 425 which decomposes or tokenizes the transformed data set before transmission to search query task tokenizer 430.

Search query task tokenizer 430 may be configured to extract one or more key attributes, features, and/or attributes from the tokenized search query and/or tokenized data set. Semantic affinity evaluation engine 435 may be configured to perform semantic analysis on the extracted key attributes, features, and/or other attributes from the tokenized search query and/or data set. Semantic affinity evaluation engine 435 may perform a semantic analysis of the search terms in the tokenized search query and/or data set which includes identifying synonyms of the tokens using a dictionary and/or thesaurus. Semantic affinity evaluation engine 435 may generate synonym list 410 of the tokens based on the semantic analysis.

A search query may be received by machine learning engine 460 from user interface 450. Machine learning engine 460 may include a machine learning model which takes one or more search terms or key attributes as input. Machine learning engine 460 may use one or more images in product images store 470 to determine a set of images corresponding to the search query. In addition, machine learning engine 460 may use images in product images store to determine and/or combine images resulting in images 455.

Keyword template generator 465 may be included in the NLP service manager utilize a document store instance 485 generating a template with one or more image-keys, key attributes, and/or features. The template may be sent to machine learning engine 460 which may be used in training a machine learning model and in determining and/or generating images 455. Relationships determined based on the analysis and generated template may be used to generate an entity-relationship index instance 480 for determining a learned checkpoint that may be saved in checkpoint instance 475.

Keyword filter and identifier 440 may be configured to identify and/or filter one or more key attributes associated with the search query. The filtered one or more key attributes may be transmitted to semantic affinity evaluation engine 435 for semantic analysis. The filtered one or more key attributes may be used to determine if there is currently an inventory of a product or item with the features of one or more key attributes at inventory instance 445. If there is a product or item in the inventory with features that include one or more of the key attributes, then the image of the product and/or item may be transmitted to machine learning engine 460 as input and included in images 455.

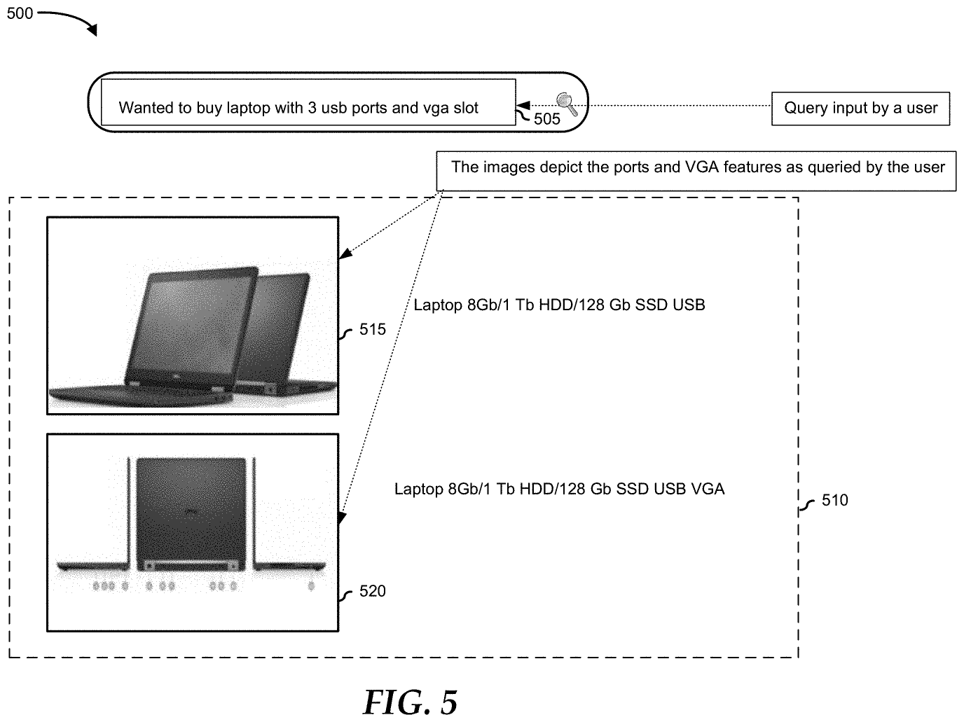

FIG. 5 shows a portion of page 500 that has been automatically populated with query-based images according to user intent and search query context. Page 500 includes a search query 505 and a search result 510. Search query 505 may have been inputted by a user via a user interface. Search result 510 includes a set of images with associated text such as image 515 and image 520. Image 515 is an example of a single top-ranked image that includes a maximum number of features that correspond to key attributes in the search query. Image 515 shows the VGA slot and USB ports. Image 520 is an example of a clubbed image to show features corresponding to one or more key attributes in the search query. The clubbed image may be images of different views of the same laptop or at least the same laptop brand and model from the same site, such that the clubbed image shows the key attributes of the search query. This allows the user to perform the intent to buy the laptop. Here, image 520 shows a combination of three different images that includes a lateral view, a back view and a side view of the laptop. The three different images are combined with one or more labels highlighting the key attributes the user is looking for, such as the VGA slot and the HDMI slot.

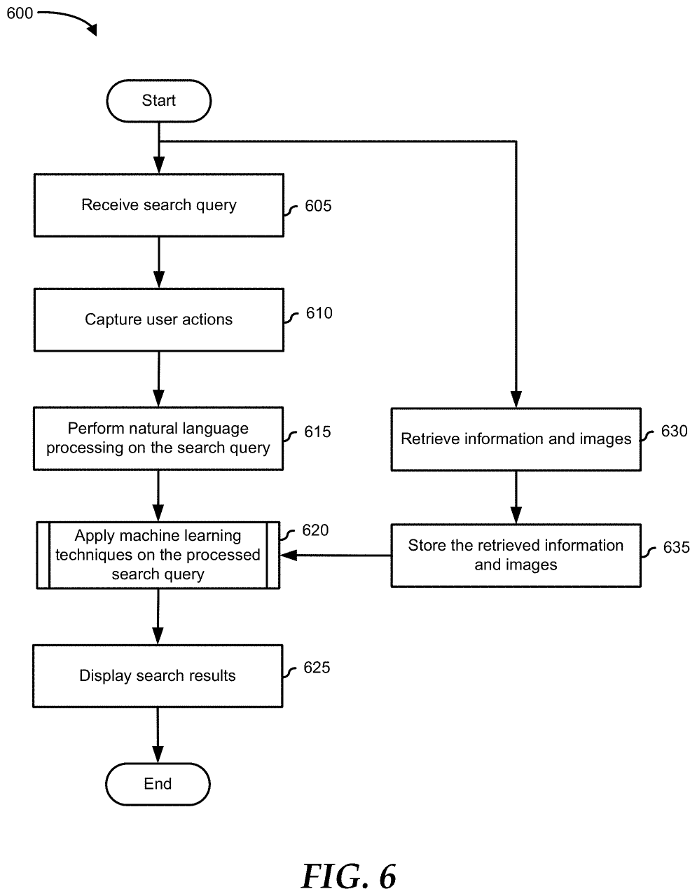

FIG. 6 shows a flowchart of method 600 for automatically populating a search result with query-based images according to user intent and context of the search query. Method 600 may be performed by one or more components of system 200 of FIG. 2, system 300 of FIG. 3, and system 400 of FIG. 4. While embodiments of the present disclosure are described in terms of system 200 of FIG. 2, system 300 of FIG. 3, and system 400 of FIG. 4, it should be recognized that other systems may be utilized to perform the described method. One of skill in the art will appreciate that this flowchart explains a typical example, which can be extended to advanced applications or services in practice.

A portion of the pseudocode of method 600 is shown below:

Search_query_text=“wand to buy laptops with USB ports, with VGA and HDMI slots”

Non_corrected_tokenized_word=word_tokenize(search_text)

For word in non_corrected_tokenized_word: tokenized_word.append(spell.correction(word))

//now we can lemmatize to determine the standard word

lemma=WordNetLemmatizer()

lemmed_words=[]

for w in tokenized word: lemmed_words.append(lem.lemmatize(w, “v”)

//now we can tag the lemmatized word and determine the domain and key words

pos_tagged_words=nitk.pos_tag(lemmed_words)

print(“Tagged sentence: “, pos_tagged_words)

Method 600 typically starts at block 605 where a search query is received from a user, wherein the search query includes one or more search terms. At block 610, the method captures the user's actions or interactions. For example, the method may capture user interactions with various websites, such as items viewed, items purchased, items clicked, etc. Block 615 performs natural language processing on the search terms of the search query. The text of the search query in its original format may be tokenized to determine key attributes and its output is shown below:
Search query text =“wand to buy laptops with USB ports, with VGA and HDMI slots”
Output=[‘wand’, ‘to’, ‘buy’, ‘laptop’, ‘with’, ‘USB’, ‘ports’, ‘,’, ‘VGA’, ‘and’, ‘HDMI’, ‘slots’]

A spelling check may be conducted on the text or search terms of the search query. The spelling check may be based on the context of the search query. For example, “wand” is a correct spelling for a legitimate word, but in the context of the search query, the spell check feature may determine that is misspelled and the user intended to use the word “want” instead. None of the keywords associated with the product will be changed due to corrections in spelling. After correcting misspelled words, the output is shown below:
Spell checked output=[‘want’, ‘to’, ‘buy’, ‘laptop’, ‘with’, ‘USB’, ‘ports’, ‘, ’, ‘VGA’, ‘and’, ‘HDMI’, ‘slots’]

Lemmatization can then be performed on the text in the spell-checked output to convert the vocabulary into a standard NLP input vocabulary. In the example above, the plural words “ports” and “slots” are lemmatized into their singular form. Shown below is the output after lemmatization:
Lemmatized output=[‘want’, ‘to’, ‘buy’, ‘laptop’, ‘with’, ‘USB’, ‘port’, ‘,’, ‘VGA’, ‘and’, ‘HDMI’, ‘slot’]

At block 620, the method applies machine learning techniques to the processed search query. In particular, the method applies machine learning techniques to the output of the NLP service manager. At block 625, the method displays the search results similar to shown in FIG. 5. At block 630, the method retrieves information and images from various sites. The method may also retrieve information associated with user interaction. The retrieved information, images, and/or user interactions may be stored in a data store to be used by the machine learning engine at block 635. After displaying the search results, the method ends.

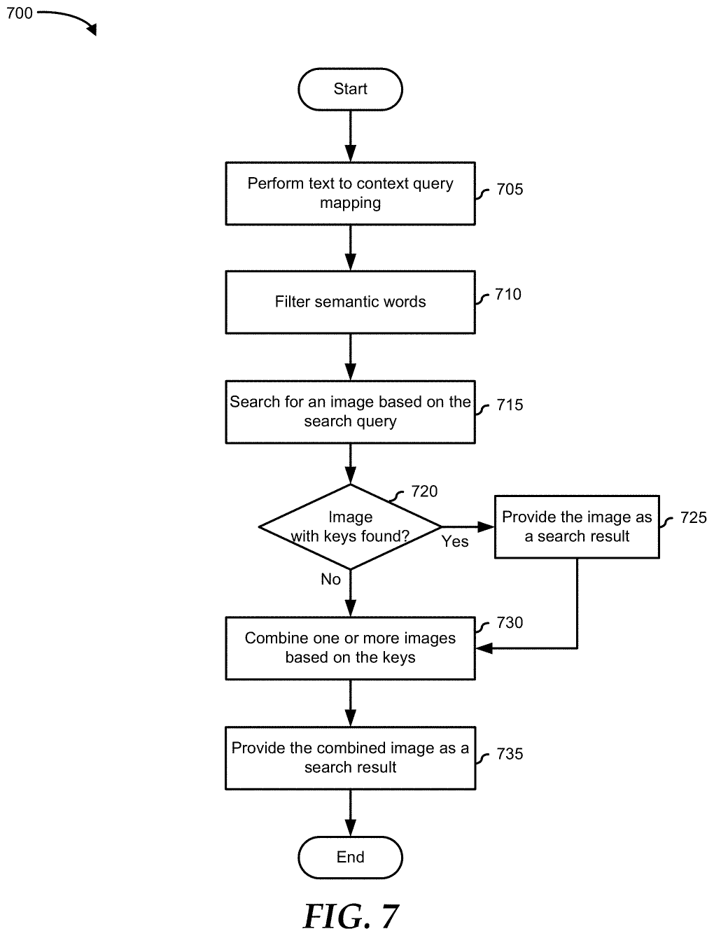

FIG. 7 shows a flowchart of method 700 for automatically populating a search result with query-based images based on user intent and search query context. Method 700 illustrates block 620 of FIG. 6. While embodiments of the present disclosure are described in terms of system 200 of FIG. 2, it should be recognized that other systems may be utilized to perform the described method.

At block 705, the method may perform a text to context query mapping. The text(s) or search terms in the lemmatized output are tagged and the domain and keywords or key attributes are determined. A tag as used herein is a word or group of words that provide a useful way to group related words. An example of the output after the tagging is shown below:
Tagged output=[(‘want’, ‘NN’), (‘to’, ‘IN’), (‘buy’, ‘VB’), (‘laptop’, ‘JJ’), (‘with’, ‘IN’), (‘USB’, ‘NNP’), (‘Port’, ‘NNP’), (‘,’, ‘,’), (‘with’, ‘IN’), (‘VGA’, ‘NNS’), (‘and’ ‘CC’), (‘HDMI’, ‘NNS’), (‘Slot’, ‘NNS’)]

In the example above, the text in the lemmatized output are tagged according to different parts of speech as shown in the legend below:

NN: Noun

VB: Verb

JJ: Primary Noun

IN: Conjunction

NNS: Auxiliary Nou

Here, the word “laptop” is tagged as a primary noun and as the domain which tells the system that the user is searching for a laptop. Also, the word “buy” is tagged as a verb, which is determined to be the user's intent. The words “USB”, “port”, “VGA”, “HDMI”, and “slot” are tagged as auxiliary nouns and identified as keywords or key attributes. Now, we can generate a tree that represents the text in the search query, such as shown below:

### Domain (Laptop)

### ↓

### Intent (Buy)

### ↓

### Key Words (VGA, VGA, USB, Port, VGA, HDMI, Slot)

At block 710, the method may filter semantic words and generate a synonym list. The synonym list may be used to search for images with tags that are synonyms of the tokens, search terms, or key attributes of the search query. At block 715, the method searches at one or more sites or data store(s) for a set of images based on the search query.

At decision block 720, the method determines whether there are one or more images whose features include all of the determined key attributes based on the search query. If there are one or more images that include all of the key attributes then the “YES” branch is taken and the method proceeds to block 725. If there is no image found that includes all of the key attributes, then the “NO” branch is taken and the method proceeds to block 730.

At block 725, the method provides one or more images to the user as a search result. Such is responsive to determining that the search result includes the image with the feature corresponding to the key attribute. At block 730, the method combines one or more images to generate at least one image that includes the key attributes of the search query. Based on the example above, the method may generate an image of a laptop that includes an HDMI, VGA, and USB ports as shown in image 515 of FIG. 5. One of skill in the art will appreciate that this flowchart explains a typical example, which can be extended to advanced applications or services in practice.

Although FIG. 6 and FIG. 7 show example blocks of method 600 and method 700 in some implementation, method 600 and method 700 may include additional blocks, fewer blocks, different blocks, or differently arranged blocks than those depicted in FIG. 6 and FIG. 7. Additionally, or alternatively, two or more of the blocks of method 600 and method 700 may be performed in parallel. For example, block 705 and block 710 of method 700 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

1. A method comprising:
receiving, at a processing device, a search query from a user, wherein the search query includes a first search term and a second search term;
determining a first key attribute and a second key attribute respectively associated with the first search term and the second search term;
determining an intent of the user and a context of the search query based on the first key attribute and on the second key attribute;
determining whether a search result corresponding to the search query includes an image with a first feature corresponding to the first key attribute and a second feature corresponding to the second key attribute;
responsive to determining that the search result does not include the image with the first feature corresponding to the first key attribute and the second feature corresponding to the second key attribute, generating a clubbed image that includes a first image and a second image, wherein the first image includes the first feature and the second image includes the second feature, and wherein the first image and the second image have different views; and
displaying the clubbed image to the user as part of the search result in response to the search query.

2. The method of claim 1, responsive to determining that the search result includes the image with the first feature and the second feature corresponding to the first key attribute and the second key attribute, displaying the image to the user as part of the search result in response to the search query.

3. The method of claim 1, wherein the search result includes a set of images.

4. The method of claim 1, wherein the search result is based on the intent of the user and the context of the search query.

5. The method of claim 1, further comprising performing mapping of the first search term to the first key attribute.

6. The method of claim 1, further comprising classifying images in a data store according to a domain.

7. The method of claim 6, wherein each one of the images includes a tag according to a particular feature.

8. The method of claim 1, wherein the first image includes features with a maximum number of matches to key attributes of the search query.

9. The method of claim 1, wherein the second image includes other features that match remaining key attributes of the search query.

10. The method of claim 1, further comprising capturing user actions.

11. An information handling system, comprising:
a user interface configured to receive a search query from a user and to display a search result corresponding to the search query, wherein the search query includes a first search term and a second search term; and
a processing device configured to:
determine a first key attribute associated with the first search term and a second key attribute associated with the second search term;
determine an intent of the user and context of the search query based on the first key attribute;
determine whether the search result corresponding to the search query includes an image with a first feature corresponding to the first key attribute and a second feature corresponding to the second key attribute;
responsive to a determination that the search result does not include the image with the first feature and the second feature, generate a clubbed image that includes a first image and a second image, wherein the first image includes the first feature and the second image includes the second feature, and wherein the first image and the second image have different views; and
display the clubbed image to the user as part of the search result in response to the search query.

12. The information handling system of claim 11, responsive to another determination that the search result includes the image with the first feature and the second feature, displaying the image to the user as part of the search result.

13. The information handling system of claim 11, wherein the search result is based on the intent of the user and the context of the search query.

14. The information handling system of claim 11, further comprising determining if a particular image includes the first feature and the second feature corresponding to the first key attribute and the second key attribute respectively.

15. The information handling system of claim 11, wherein the processing device is further configured to map the first search term to the first key attribute.

16. A non-transitory computer-readable medium including code that when executed performs a method, the method comprising:
receiving a search query including a first search term and a second search term;
determining a first key attribute associated with the first search term and a second key attribute associated with the second search term;
determining an intent and context of the search query based on the first key attribute and the second key attribute;
determining whether a search result corresponding to the search query includes an image with a first feature corresponding to the first key attribute and a second feature corresponding to the second key attribute;
if the search result does not include the image with the first feature and the second feature, generating a clubbed image that includes a first image and a second image, wherein the first image includes the first feature and the second image includes the second feature, and wherein the first image and the second image have different views; and
displaying the clubbed image as part of the search result in response to the search query.

17. The method of claim 16, responsive to determining that the search result includes the image that includes the first feature and the second feature, displaying the image to the user as part of the search result.

18. The method of claim 16, wherein the search result is based on the intent and the context of the search query.

19. The method of claim 16, further comprising determining if a particular image includes features that match the first key attribute and the second key attribute.

20. The method of claim 16, further comprising performing mapping of the first search term to the first key attribute.
